(19) United States
(12) Patent Application Publication
(10) Pub. No.: US 2025/0117814 A1
(43) Pub. Date: Apr. 10, 2025

(54) DYNAMIC FREQUENTLY ASKED QUESTIONS USING LARGE LANGUAGE MODELS

(71) Applicant: Alby Al, Inc., Brooklyn, NY (US)

(72) Inventors: Max Bennett, New York, NY (US); Kenny Teng, Brooklyn, NY (US); Daniel Stekol, Brooklyn, NY (US)

(21) Appl. No.: 18/589,343

(22) Filed: Feb. 27, 2024

Related U.S. Application Data
(60) Provisional application No. 63/542,995, filed on Oct. 6, 2023.

(51) Int. Cl. G06Q 30/0201; G06F 16/332; G06Q 30/0601

(52) U.S. Cl. CPC G06Q 30/0201; G06F 16/3329; G06Q 30/0627

(57) ABSTRACT

Exemplary embodiments include systems and methods for generating dynamic questions and answers for a customer of an ecommerce store, the systems and methods comprising: a database storing context information regarding products listed on the ecommerce store; a user interface element supported by the ecommerce store, configured to receive a query and further configured to populate an answer to the query and a predicted follow-up question; a server coupled to the user device; and a large language model coupled to the source database and the server. The large language model is configured to: generate an initial set of product-related questions using context information for products listed on the ecommerce store; receive the query; prepare a contextual response to the query using a pre-configured prompt, the query, and the information regarding the product stored in the at least one source database; and generate and display the contextual response and predicted follow-up question.

### CROSS REFERENCE TO RELATED APPLICATIONS

The present application claims the priority benefit of U.S. Provisional Patent Application Ser. No. 63/542,995, filed on Oct. 6, 2023, titled “Personalized Frequently Asked Questions Using Large Language Models”. This application is hereby incorporated by reference in its entirety, including all appendices.

### FIELD OF THE TECHNOLOGY

Embodiments of the disclosure relate to Large Language Models, and in particular, but not by limitation, to their application in generating responses to user queries, including question-and-answer pairs.

### SUMMARY OF EXEMPLARY EMBODIMENTS

Embodiments of the disclosure include systems and methods for generating dynamic questions and answers for a customer of an ecommerce store. An exemplary system comprises: at least one source database storing context information regarding one or more products listed on the ecommerce store; at least one user interface element supported by the ecommerce store, the user interface element displayable on a graphical user interface on a user device and configured to receive at least one user query and further configured to populate at least one answer to the user query and at least one predicted follow-up question; at least one server comprising at least one processor and memory for storing instructions executable on the processor, the at least one server communicatively coupled to the user device over a network connection; and at least one large language model communicatively coupled to the at least one source database and the at least one server, the at least one large language model being trained using data stored in the at least one source database, the at least one large language model being configured to: generate an initial set of at least one product-related question using the context information for each of the one or more products listed on the ecommerce store; receive the at least one user query from the user device, the user query comprising a query for information regarding the product listed on the ecommerce store; prepare a contextual response to the user query using a pre-configured prompt, the at least one user query, and the information regarding the product stored in the at least one source database; and generate and display the contextual response and the at least one predicted follow-up question.

In some embodiments, the at least one user query being submitted as any one of: a clickable link having the text of the at least one product-related question, and a plain text query generated by the user.

In some embodiments, the systems and methods further comprise a conversation agent configured to record a customer's browse behavior on an ecommerce store and an identifier of the customer. In such embodiments, the large language model further configured to generate the contextual response to the at least one user query and the follow-up question based on the customer's browse behavior and the identifier as recorded by the conversation agent.

Some embodiments further comprise a caching means communicatively coupled to the server, the caching means configured to cache frequently asked questions and question-answer pairs; and a retrieval unit configured to fetch cached answers for the frequently asked questions and the question-answer pairs and display them without invoking the large language model.

In some embodiments, the large language model is trained, at least in part, by collecting training data comprising one or more of: product details posted on a page on the ecommerce store, including but not limited to the product page itself; articles, blogs, and content available online regarding the product; purchasing guides with information regarding specifications, such as sizing, dimensions, and customization options; product image information; customer reviews and feedback, including written reviews and ratings; and customer-posted questions and answers to the customer-posted questions from other customers or from online sellers.

The collected training data is processed to create training prompts simulating real-world scenarios where a hypothetical customer seeks product-related information based on the hypothetical customer's history and context. The large language model is trained using the training prompts to predict most likely questions the hypothetical customer might have about a product. In some embodiments, the large language model's predictions are refined using feedback received from actual customer interactions on the ecommerce store.

In some embodiments, the training data further comprises customer browse behavior, customer context information, and customer queries related to one or more of the products.

In some embodiments, the large language model is further configured to generate a plurality of frequently asked questions and a subset within the plurality of the frequently asked questions, the subset to be displayed within the user interface element. Some such embodiments include a scoring means for determining an optimal set of questions to feature as the subset within the plurality of frequently asked questions, the determination being based at least in part on input comprising at least one of: sales trends, browse rate, click rate, browse-to-purchase ratio, and click-to-purchase ratio.

In some embodiments, the scoring means comprises a deep neural network configured to receive the input at a first input layer; process the input by one or more hidden layers; generate a first output; transmit the first output to an output layer; generate a first outcome comprising the determining of the optimal set of questions; and transmitting the first outcome to the input layer as further input.

### BRIEF DESCRIPTION OF THE DRAWINGS

In the description, for purposes of explanation and not limitation, specific details are set forth, such as particular embodiments, procedures, techniques, etc. to provide a thorough understanding of the present technology. However, it will be apparent to one skilled in the art that the present technology may be practiced in other embodiments that depart from these specific details.

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is an example system that comprises various modules that can be executed to provide the FAQ features described herein.

FIG. 2 is an example screenshot of a webpage and application providing the LLM-based FAQ.

FIG. 3 presents an exemplary deep neural network.

FIG. 4 diagrammatically illustrates a method for determining optimal subsets of LLM-based FAQs to post on a webpage.

FIG. 5 is a further example screenshot of a webpage and application providing the LLM-based generative questions and answers.

FIGS. 6A and 6B depict a further example of a webpage and application providing the LLM-based generative questions and answers.

### DETAILED DESCRIPTION OF EXEMPLARY EMBODIMENTS

Customers often have questions about products before a purchase is made. However, brands cannot easily answer every question, because it is expensive to have humans available online to answer each of these questions. Many customers do not want to go through the belabored process of opening a live chat and waiting for a person to respond. Furthermore, many customer care agents are not actually product experts and often do not have the right answers to many of these questions.

One solution is to place a list of “frequently asked questions” on a product detail page in order to anticipate customer questions and answer them directly. However, this has several example problems. First, it is very time consuming and expensive to have employees write these “FAQs” on every product, and second, it is hard to predict what the actual most likely questions will be.

There are almost always too many questions, and too great a diversity of questions, to put all of them on the page. This would make the experience of the product detail page too busy.

To solve these challenges, Large Language Models can be used to automatically predict and generate questions and answers for each individual customer when they land on a product detail page.

As used herein, the term language model generally refers to a probability distribution over sequences of words. Language models generate probabilities by training on large and structured sets of text, or text corpora. A single text corpus may include a single language or many languages, and may have various levels of structure based on, for example, grammar, syntax, morphology, semantics, and pragmatics.

A Large Language Model, or LLM, refers to a language model consisting of a deep learning architecture that is trained on large quantities, often tens of gigabytes, of unlabeled text using self-supervised learning or semi-supervised learning to produce generalizable and adaptable output. The deep learning architecture may be comprised of a neural network with billions of weights or parameters. In some embodiments, the neural network may be a transformer, which uses parallel multi-head attention mechanism, or alternatively the neural network may be recursive, operating in sequence.

Additionally, in some embodiments, the Large Language Model is communicatively coupled with one or more source databases.

In some embodiments, frequently asked questions are generated by large language models using contextual information regarding a product or service for sale on an ecommerce store. In some of these and alternative embodiments, these frequently asked questions comprise question-answer pairs, featuring the frequently asked question and the answer to the frequently asked question. In some embodiments, both the frequently asked question and the answer to which it is paired are generated using a large language model.

As used herein, “ecommerce store” generally includes online sales platforms such as web stores, including any website, mobile app, or other digital platform where goods or services are sold or advertised. “Product” as used herein includes goods and services listed for sale in an ecommerce store. “Products” generally includes goods listed for sale or advertised, as well as services such as hotel or vacation stays, leisure activities, professional services, and other types of services, non-exhaustively. Platforms are generally supported as websites accessible by web browser or in a native application on a computer or smart device.

In some embodiments, the frequently asked questions and question-answer pairs are displayed in a widget or web component within a product detail page on the web platform. However, the questions and question-answer pairs are configurable to be displayed in various display components of a website, including product lists, online shopping cart pages, and checkout pages, non-exhaustively.

The contextual information is drawn from one or more data sources in one or more source databases, which include, in exemplary embodiments: product details posted on a page in the ecommerce store, including but not limited to the product page itself; articles, blogs, and content available online regarding the product; purchasing guides with information regarding specifications, such as sizing, dimensions, and customization options; product image information; customer reviews and feedback, including written reviews and ratings; and customer questions and answers to customer questions from other customers or from online sellers.

Additional data sources include data regarding the sales of a product, including purchase history and trends; and ratios such as browse-to-purchase ratio, or conversion rate.

In some embodiments, the system generates a large number of usable questions or question-answer pairs and subsequently determines an optimal subset to display to a user. In one such example, the LLM generates fifty question-answer pairs, and the system predicts which five of the fifty questions are most likely to be useful to shoppers. In some embodiments, the determination is made algorithmically based on metrics such as word frequency in positive reviews or frequently clicked FAQs in an iterative process.

In further embodiments, the system uses machine learning methods featuring one or more neural networks trained and tuned for precision using information related to contextual information regarding a product.

In some embodiments, a click on one or more frequently asked questions generates a new list of related frequently asked questions within the online display.

By way of example, using the systems and methods disclosed herein, a customer of an ecommerce store clicks one frequently asked question link. The customer click causes the system to send a prompt to at least one LLM. An exemplary prompt reads:
“You are a salesperson product expert for {{online seller}}. Answer the following question: {{question}} based on the following contextual information: {{insert contextual information}};
“Provide a list of exactly {{number of questions to generate}} additional questions the customer might ask.”

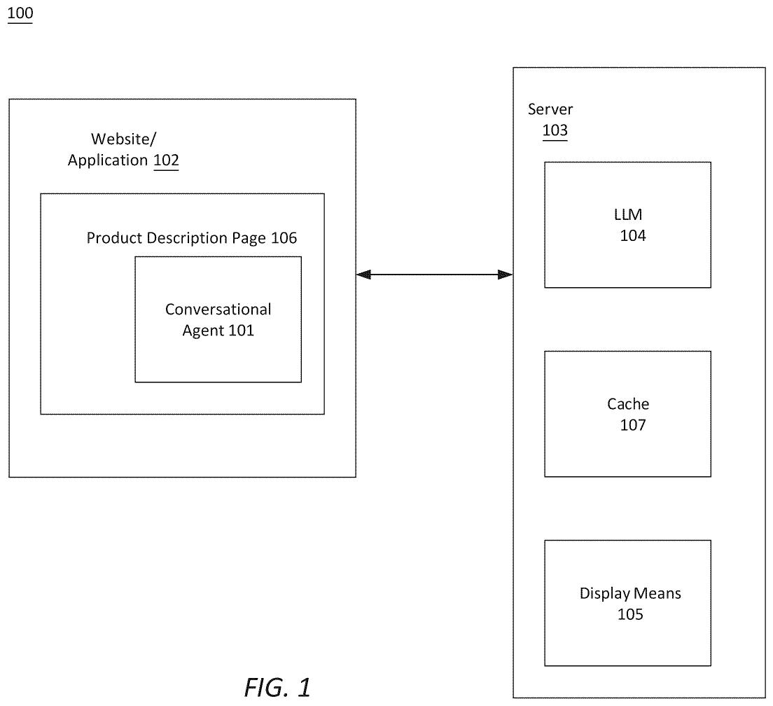

FIG. 1 is an example system that comprises various modules that can be executed to provide the FAQ features described herein. The system 100 includes a tracking means configured to record activity related to a product listed by an ecommerce store interfaced on a website or application 102. Such products are generally listed on a web page 106, but may also be depicted in, for example, home pages, lists of related products, online shopping carts, and checkout pages. In the exemplary embodiment, the system includes a server 103 configured to receive information collected from the tracking means. The system further includes an LLM 104 receiving input from the server and producing a set of questions based on information collected from the tracking means. The LLM produces a set of questions based on the information collected from the tracking means and the product details. In some embodiments, the system further comprises a display means 105, (graphical user interface generator) configured to show the questions in a widget on, for example, the product detail page 106 of the website or application 102. In some embodiments, the server 102 includes a caching unit 107 configured to store responses from the LLM for previously answered questions and fetch cached answers. The system may thus display question-answer pairs in some cases without the need to invoke the LLM.

Some exemplary embodiments include customer-specific tracking means. In some such embodiments, the system 100 includes a tracking means (such as a conversational agent 101) configured to record a customer's browse behavior on a brand's website or application 102. The server 103 is configured to receive the customer's browse behavior and an identifier of the customer and to retrieve additional customer context information. The LLM 104 receives input from the server and produces a set of questions based on the customer's history and product details.

In some embodiments, a brand places a widget in a div tag on their product detail page where dynamic FAQs will be populated. In customer-specific embodiments, JavaScript tracks a customer's browse behavior on the brand's website within that session (either in an application or on a website), which includes: Pages visited (products viewed, articles read, and so forth); Actions taken (searching, adding to cart); and Messages sent (any previous conversations with a chat system).

In some embodiments, when a customer lands on a product detail page (PDP), a request is made that contains all of the customer's browse behavior and an identifier of the customer to a server. This server can also look up information on that customer such as previous order history, loyalty information, and further information. The server then passes this information to an LLM that has been trained to predict the most likely questions a customer will ask given their historical behavior.

An example prompt could be as follows:

A customer on {{website}} just viewed the following actions:
{{visit and action history}}

Here is some context on this customer:
{{customer purchase history}}

The customer is now on the page for {{product name}}. Please provide the three most likely questions a customer will have about this product, given their history. These questions are then presented in the div on the product detail page.

If the customer clicks on the question, then it makes another request to the server to the normal question-answer LLM that then answers the customer question. In some embodiments, the system can cache responses so if someone ever asks the same question on product, then it can respond with the answer in real time, without computing the answer.

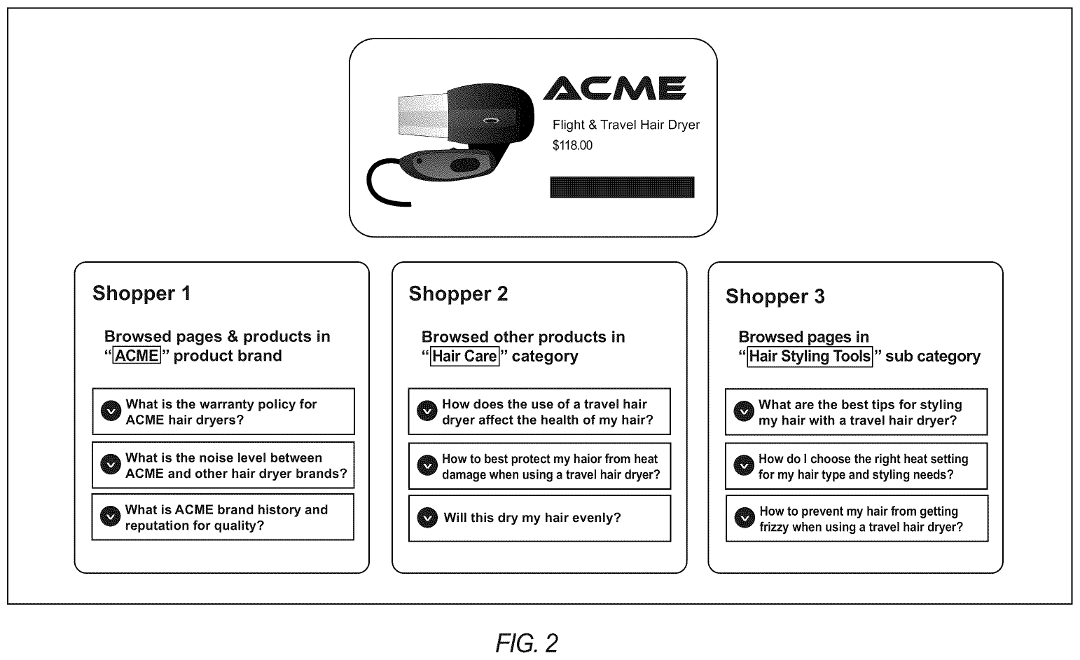

FIG. 2 is an example screenshot of a webpage and application providing the LLM-based FAQ. As illustrated, the system generates example questions based on product information from data sources including, for example: product details posted on a page on the ecommerce store, including but not limited to the product page itself; articles, blogs, and content available online regarding the product; purchasing guides with information regarding specifications, such as sizing, dimensions, and customization options; product image information; customer reviews and feedback, including written reviews and ratings; and customer questions and answers to customer questions from other customers or from online sellers.

Additional data sources include data regarding the sales of a product, including purchase history and trends; and ratios such as browse-to-purchase ratio, or conversion rate.

In some embodiments, the system generates example questions based on the collected browsing history of the user (as well as other information discussed herein). As noted above, if the customer clicks on the question, then it makes another request to the server to the normal question-answer LLM that then answers the customer question.

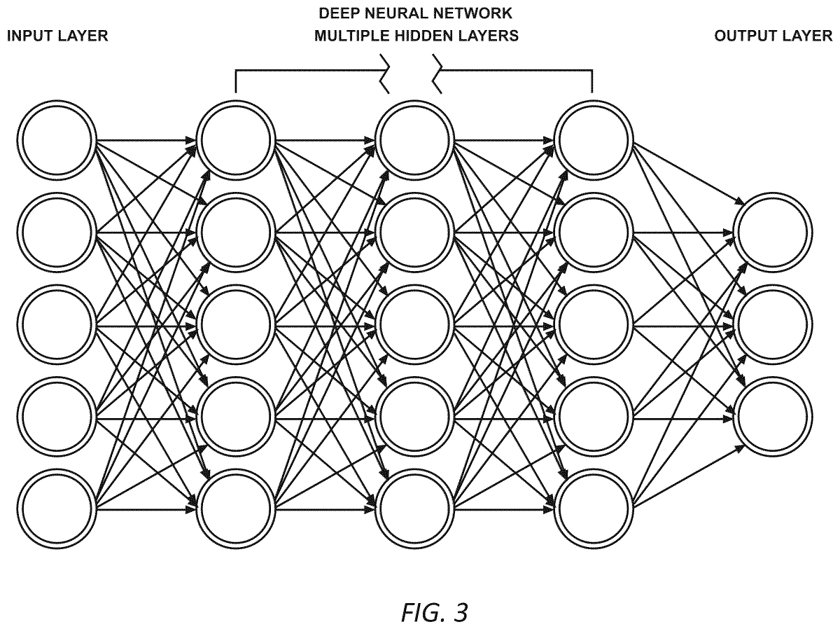

FIG. 3 shows an exemplary deep neural network. Neural networks, also known as artificial neural networks (ANNs) or simulated neural networks (SNNs), are a subset of machine learning and are at the heart of deep learning algorithms. Their name and structure are inspired by the human brain, mimicking the way that biological neurons signal to one another. Artificial neural networks (ANNs) are comprised of node layers, comprising an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network.

Neural networks rely on training data to learn and improve their accuracy over time. However, once these learning algorithms are fine-tuned for accuracy, they are powerful tools in computer science and artificial intelligence, allowing one to classify and cluster data at a high velocity. Tasks in speech recognition or image recognition can take minutes versus hours when compared to the manual identification by human experts.

In some exemplary embodiments, one should view each individual node as its own linear regression model, composed of input data, weights, a bias (or threshold), and an output. Once an input layer is determined, weights are assigned. These weights help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming the input of the next node. This process of passing data from one layer to the next layer defines this neural network as a feedforward network. Larger weights signify that particular variables are of greater importance to the decision or outcome.

According to some exemplary embodiments, deep neural networks are feedforward, meaning they flow in one direction only, from input to output. However, one can also train a model through backpropagation; that is, move in the opposite direction from output to input. Backpropagation allows one to calculate and attribute the error associated with each neuron, allowing one to adjust and fit the parameters of the model(s) appropriately.

In machine learning, backpropagation is an algorithm for training feedforward neural networks. Generalizations of backpropagation exist for other artificial neural networks (ANNs), and for functions generally. These classes of algorithms are all referred to generically as “backpropagation”. In fitting a neural network, backpropagation computes the gradient of the loss function with respect to the weights of the network for a single input-output example, and does so efficiently, unlike a naive direct computation of the gradient with respect to each weight individually. This efficiency makes it feasible to use gradient methods for training multilayer networks, updating weights to minimize loss; gradient descent, or variants such as stochastic gradient descent, are used. The backpropagation algorithm works by computing the gradient of the loss function with respect to each weight by the chain rule, computing the gradient one layer at a time, iterating backward from the last layer to avoid redundant calculations of intermediate terms in the chain rule; this is an example of dynamic programming. The term backpropagation strictly refers only to the algorithm for computing the gradient, not how the gradient is used; however, the term is often used loosely to refer to the entire learning algorithm, including how the gradient is used, such as by stochastic gradient descent. Backpropagation generalizes the gradient computation in the delta rule, which is the single-layer version of backpropagation, and is in turn generalized by automatic differentiation, where backpropagation is a special case of reverse accumulation (or “reverse mode”).

According to some exemplary embodiments, the system produces an output, which in turn produces an outcome, which in turn produces an input. In some embodiments, the output may become the input. Deep Neural Networks can be used to support Large Language Models, or LLMs.

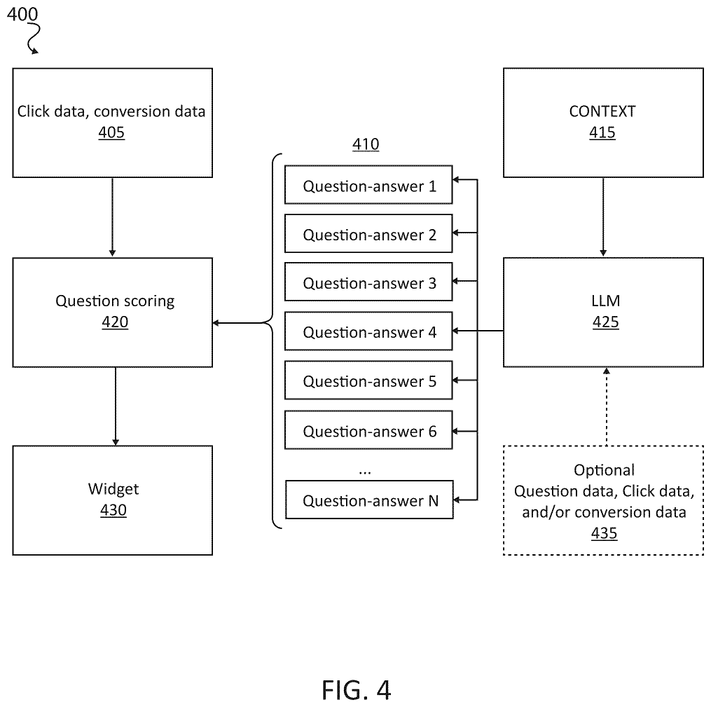

FIG. 4 diagrammatically illustrates a method for determining optimal subsets of LLM-based FAQs to post on a webpage. An LLM 425 generates a plurality of predicted questions 410 for an FAQ section in a widget 430, or user interface element, in an ecommerce store. The LLM draws from a database having context 415 about one or more products listed by the ecommerce store, and in some embodiments, draws from question data, click data, and/or conversion data 435. A question scoring agent 420 determines an optimal subset of questions from the plurality of predicted questions 410 to be listed in the widget 430.

In some embodiments, the scoring agent 420 bases its determination at least in part on input comprising at least one of: sales trends, browse rate, click rate, browse-to-purchase ratio, and click-to-purchase ratio.

In some embodiments, the scoring agent 420 is implemented deep neural network configured to receive the input at a first input layer; process the input by one or more hidden layers; generate a first output; transmit the first output to an output layer; generate a first outcome comprising the determining of the optimal set of questions. In some embodiments, the first outcome is transmitted back to the input layer as further input.

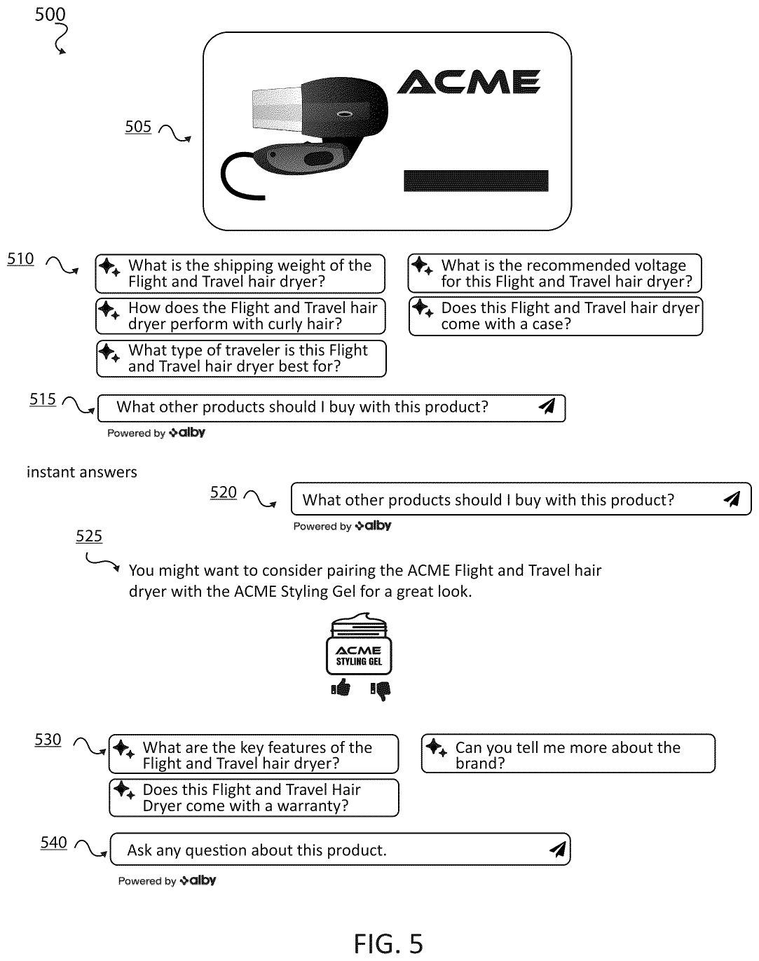

FIG. 5 is a further example screenshot of a webpage and application providing the LLM-based generative questions and answers. An ecommerce store hosts a widget having pre-determined FAQs 510 related to a product 505 and prepared by an LLM trained on data related to the product. In this embodiment, the pre-determined FAQs 510 are presented in clickable format, where a customer clicks a question to generate an answer 525 prepared by the LLM. Alternatively, the customer submits a plain text query 515 to the LLM to generate the answer 525. In some embodiments, the widget displays the question as repeated 520 along with the answer 525.

Along with the answer 525, in some embodiments, the LLM generates one or more follow-up questions 530 related to the product. In this exemplary embodiment, a follow-up prompt to ask any question 540 is also presented.

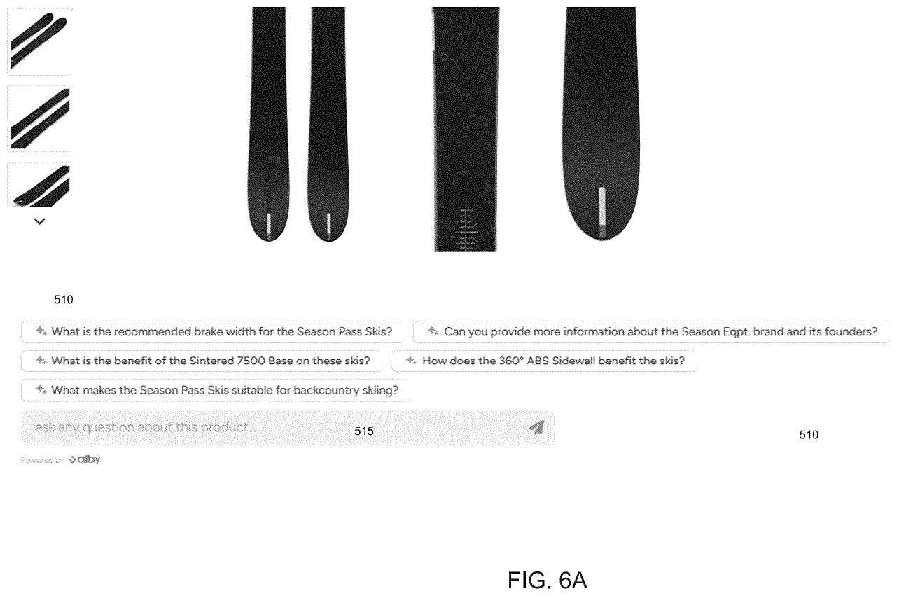

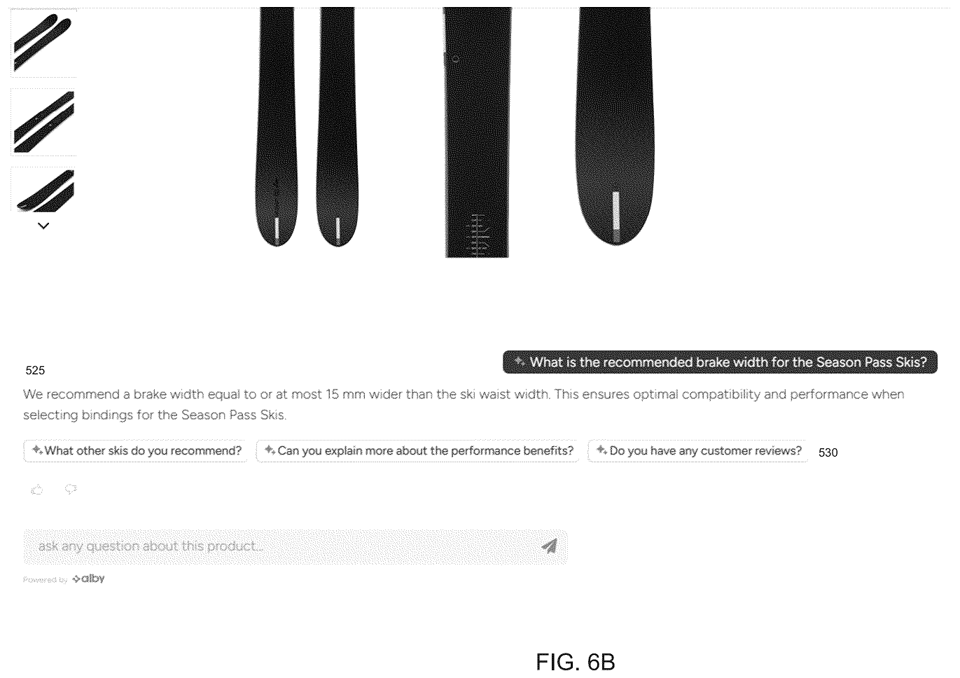

FIGS. 6A and 6B depict a further example of a webpage and application providing the LLM-based generative questions and answers. In FIG. 6A, an initial set of predetermined FAQs 510 are depicted in a widget on a webpage listing a product 505, in this case a pair of skis. The pre-determined FAQs 510 are presented in clickable format. The widget also supports submission of a plain text query 515.

FIG. 6B depicts the appearance of the user interface when any one of the predetermined FAQs 510 are selected, or when a plain text query 515 is submitted. In this case, the question “What is the recommended brake width for the Season Pass Skis?” has been clicked. The LLM generates an answer 525, “We recommend a brake width equal to or at most . . . ”, along with three more follow-up questions 530.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

We claim:

1. A system for generating dynamic questions and answers for a customer of an ecommerce store, the system comprising:
at least one source database storing context information regarding one or more products listed on the ecommerce store;
at least one user interface element supported by the ecommerce store, the user interface element displayable on a graphical user interface on a user device and configured to receive at least one user query and further configured to populate at least one answer to the user query and at least one predicted follow-up question;
at least one server comprising at least one processor and memory for storing instructions executable on the processor, the at least one server communicatively coupled to the user device over a network connection; and
at least one large language model communicatively coupled to the at least one source database and the at least one server, the at least one large language model being trained using data stored in the at least one source database, the at least one large language model being configured to:
generate an initial set of at least one product-related question using the context information for each of the one or more products listed on the ecommerce store;
receive the at least one user query from the user device, the user query comprising a query for information regarding the product listed on the ecommerce store;
prepare a contextual response to the user query using a pre-configured prompt, the at least one user query, and the information regarding the product stored in the at least one source database; and
generate and display the contextual response and the at least one predicted follow-up question.

2. The system of claim 1, the at least one user query being submitted as any one of: a clickable link having the text of the at least one product-related question, and a plain text query generated by the user.

3. The system of claim 1, further comprising a conversation agent configured to record a customer's browse behavior on an ecommerce store and an identifier of the customer.

4. The system of claim 3, the large language model further configured to generate the contextual response to the at least one user query and the follow-up question based on the customer's browse behavior and the identifier as recorded by the conversation agent.

5. The system of claim 1, further comprising:
a caching means communicatively coupled to the server, the caching means configured to cache frequently asked questions and question-answer pairs; and
a retrieval unit configured to fetch cached answers for the frequently asked questions and the question-answer pairs and display them without invoking the large language model.

6. The system of claim 1, the configuring of the large language model including training the large language model, at least in part, by:
collecting training data comprising one or more of: product details posted on a page on the ecommerce store, including but not limited to the product page itself; articles, blogs, and content available online regarding the product; purchasing guides with information regarding specifications, such as sizing, dimensions, and customization options; product image information; customer reviews and feedback, including written reviews and ratings; and customer-posted questions and answers to the customer-posted questions from other customers or from online sellers;
processing the training data to create training prompts simulating real-world scenarios where a hypothetical customer seeks product-related information based on the hypothetical customer's history and context;
training the large language model using the training prompts to predict most likely questions the hypothetical customer might have about a product; and
refining the large language model's predictions using feedback received from actual customer interactions on the ecommerce store.

7. The system of claim 6, the training data further comprising customer browse behavior, customer context information, and customer queries related to one or more of the products.

8. The system of claim 1, the large language model further configured to generate a plurality of frequently asked questions and a subset within the plurality of the frequently asked questions, the subset to be displayed within the user interface element.

9. The system of claim 8, further comprising a scoring means for determining an optimal set of questions to feature as the subset within the plurality of frequently asked questions, the determination being based at least in part on input comprising at least one of: sales trends, browse rate, click rate, browse-to-purchase ratio, and click-to-purchase ratio.

10. The system of claim 9, the scoring means comprising a deep neural network configured to receive the input at a first input layer; process the input by one or more hidden layers; generate a first output; transmit the first output to an output layer; and generate a first outcome comprising the determining of the optimal set of questions.

11. A method for generating dynamic questions and answers for a customer of an ecommerce store, the method comprising:
training a large language model using context information stored in at least one source database, the information pertaining to one or more products listed by the ecommerce store;
preparing a pre-configured prompt for a context-appropriate response to at least one user query by the large language model;
generating an initial set of at least one product-related question using the context information for each of the one or more products listed on the ecommerce store; receiving at least one user query regarding at least one of the one or more products, the at least one query being submitted by a user interface element supported by the ecommerce store, the user interface element configured to receive the at least one user query and to populate an answer to the at least one user query and at least one follow-up question, the user interface element displayed on a user device communicatively coupled with the large language model by way of at least one server;
preparing, by the large language model, a contextual response to the at least one user query using the pre-configured prompt and the information regarding the product stored in the at least one source database; and
generating, by the large language model, the answer to the user query and the at least one follow-up question.

12. The method of claim 11, the at least one user query being submitted as any one of: a clickable link having the text of the at least one product-related question, and a plain text query generated by the user.

13. The method of claim 11, further comprising receiving, by a conversation agent, a customer's browse behavior on the ecommerce store and an identifier from the customer.

14. The method of claim 13, further comprising generating, by the large language model, the contextual response to the at least one user query and the follow-up question based on the customer's browse behavior and the identifier as recorded by the conversation agent.

15. The method of claim 11, further comprising:
caching frequently asked questions and question-answer pairs by way of a caching means communicatively coupled to the server; and
retrieving and displaying cached answers for the frequently asked questions and the question-answer pairs without invoking the large language model.

16. The method of claim 11, the configuring of the large language model including training the large language model, at least in part, by:
collecting training data comprising one or more of: product details posted on a page on the ecommerce store, including but not limited to the product page itself; articles, blogs, and content available online regarding the product; purchasing guides with information regarding specifications, such as sizing, dimensions, and customization options; product image information; customer reviews and feedback, including written reviews and ratings; and customer questions and answers to customer questions from other customers or from online sellers;
processing the training data to create training prompts simulating real-world scenarios where a hypothetical customer seeks product-related information based on the hypothetical customer's history and context;
training the large language model using the training prompts to predict the most likely questions the hypothetical customer might have about the product; and
refining the large language model's predictions using feedback received from actual customer interactions on the ecommerce store.

17. The method of claim 16, the training data further comprising customer browse behavior, customer context information, and customer queries related to one or more of the products.

18. The method of claim 11, the large language model further configured to generate a plurality of frequently asked questions and a subset within the plurality of the frequently asked questions, the subset to be displayed within the user interface element.

19. The method of claim 18, further comprising a scoring means for determining an optimal set of questions to feature as the subset within the plurality of frequently asked questions, the determination being based at least in part on input comprising at least one of: sales trends, browse rate, click rate, browse-to-purchase ratio, and click-to-purchase ratio.

20. The method of claim 19, the scoring means comprising a deep neural network configured to receive the input at a first input layer; process the input by one or more hidden layers; generate a first output; transmit the first output to an output layer; and generate a first outcome comprising the determining of the optimal set of questions.

21. A method for displaying dynamic questions and answers for a customer of an ecommerce store, the method comprising:
configuring a user interface element displayable on a graphical user interface to receive at least one user query and to populate at least one answer to the user query and at least one follow-up question;
receiving the at least one user query by a server, the at least one user query submitted on a user device communicatively coupled to the server, the server comprising a processor and a memory for storing instructions executable on the processor, the server further communicatively coupled to a large language model configured by:
training the large language model using context information stored in at least one source database, the information pertaining to one or more products listed on the ecommerce store;
generating an initial set of at least one product-related question using the context information for each of the one or more products listed on the ecommerce store;
preparing a pre-configured prompt for a context-appropriate response to the at least one user query by the large language model;
preparing, by the large language model, a contextual response to the user query using the pre-configured prompt and the information regarding the product stored in the at least one source database; and
generating, by the large language model at least one predicted follow-up question; and
displaying the contextual response and the at least one predicted follow-up question in the user interface element.
